(19) United States
(12) Patent Application Publication
(10) Pub. No.: US 2002/0092507 A1
(43) Pub. Date: Jul. 18, 2002

(54) Apparatus for improving the injection sequence in fuel injection systems

(75) Inventors: Roger Potschin, Brackenheim (DE); Anja Melsheimer, Stuttgart-Vaihingen (DE); Michael Heinzelmann, Fellbach (DE)

Correspondence Address: RONALD E. GREIGG, GREIGG & GREIGG P.L.L.C., 1423 POWHATAN STREET, UNIT ONE, ALEXANDRIA, VA, 22314, US

(73) Assignee: Robert Bosch GmbH

(21) Appl. No.: 09/994,896

(22) Filed: Nov. 28, 2001

(30) Foreign Application Priority Data
Nov. 30, 2000 (DE) 1 00 59 399.2

(51) Int. Cl. F02M 37/04

(52) U.S. Cl. 123/506; 123/446

(57) ABSTRACT

An apparatus for controlling the injection sequence in fuel injection systems having an injection nozzle that can be acted upon via a control valve which, in turn can be acted upon with fuel from a pump chamber. The control valve is actuatable by means of an electromagnet that varies the magnet valve stroke length. Via the magnet valve stroke length, the fuel supply line into a nozzle chamber of the injection nozzle is opened and closed. The control part of the control valve functions as a throttle element in a hollow chamber provided on the low-pressure side.

### BACKGROUND OF THE INVENTION

1. Field of the Invention

The invention relates to an apparatus for improving the injection sequence in fuel injection systems. By means of a unit fuel injector (UFI), the combustion chambers of a direct-injection internal combustion engine are supplied with fuel. The pump unit serves to build up an injection pressure, while via the injection nozzle, an injection of the fuel takes place. A control unit is also provided, which includes a control part, as well as a valve actuating unit for controlling the pressure buildup of the pump unit of the UFI system.

2. Description of the Prior Art

From German Patent Disclosure DE 198 35 494 A1, a unit fuel injector is known, which is intended to deliver fuel, which is at high pressure, to combustion chambers of internal combustion engines. To create a unit fuel injector (UFI) that is distinguished by a simple design, is small in size, and in particular has a fast response time, a valve actuating unit provided laterally on the injector is embodied as a piezoelectric actuator. In comparison to an electromagnet, a piezoelectric actuator as the valve actuating unit has a fast response time, since the period of time while a magnetic field is built up is omitted when piezoelectric actuators are used. The valve actuating units, whether they are electromagnets or piezoelectric actuators, have only limited influence on the flow movements, taking place in the line system of a control valve, of the fuel that is at high pressure. Thus while fast response times can be achieved, still to prevent fuel supply line systems from running empty with the attendant shortening of the injection sequences, additional structural measures must be taken.

From German Patent DE 37 28 817 C2, a fuel injection pump for an internal combustion engine has been disclosed in which once again the response behavior of a fuel control part actuatable via an electric actuator is to be improved. To that end, a passage is embodied in a drive tappet, actuatable by means of the piezoelectric actuator, in which passage a check valve is disposed that closes and opens the passage as a function of pressure. In this version from the prior art, once again, while a shortening of the response time can be achieved by using a piezoelectric actuator, nevertheless the flow behavior of the fuel in the supply line system to the nozzle chamber, surrounding the nozzle needle, of the injection nozzle can be varied only inadequately.

When the injection intervals currently demanded between the preinjection phase and the main injection phase of an injection nozzle are shortened, emptying the line system in the pump-line-nozzle (PLN)—even if only partially—is a grave problem, because a rapid, nonpulsating pressure buildup in the line system and a precisely metered injection quantity that is directly dependent thereon can be achieved only with difficulty if the line system has run empty.

### OBJECT AND SUMMARY OF THE INVENTION

In the embodiment proposed according to the invention, the control part of the control valve, which is disposed between the inlet on the pump side and the inlet bore on the nozzle side and is magnet-actuated, can be used as a throttle element, which prevents rapid emptying of the high-pressure line and the nozzle chamber, thus effectively preventing the occurrence of cavitation in the line system. The part of the control part of the control valve that acts as a throttle element brings about a delayed outflow of the high pressure, present in the inlet system and in the valve chamber of the control part, into the low-pressure side of the fuel supply system. As a result, the pressure in the system drops below the nozzle closing pressure, yet because of the control part of the control valve acting as a throttle the system does not become completely empty. Upon another pressure buildup for the main injection phase, the pressure fluctuations can thus be reduced, and the nozzle needle opens sooner and faster.

As a result, substantially shorter injection sequences between a preinjection phase and a main injection phase at an injection nozzle can be achieved. Since a pressure other than zero always prevails in the high-pressure line system to the nozzle chamber, cavitation phenomena and the severe stresses on material resulting in the pressure buildup are definitively precluded in the embodiment according to the invention.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows the courses of the high-pressure line on the pump and nozzle sides, the magnet valve stroke path, phases of electrical supply to the electromagnet, and the course of the nozzle needle stroke length, in each case plotted over the camshaft angle;

FIG. 2 shows the components of a fuel injection system, with a pump unit, electromagnet-actuated control valve, and injection nozzle part;

FIG. 2.1 is an enlarged view of throttling stages with adjacent control faces that control the outflow rate;

FIG. 2.2 shows a control part without a throttling edge;

FIG. 2.3 shows the cross-sectional course of control parts with and without throttling edges, plotted over the stroke; and

FIG. 3 shows the courses of the pressure in the line toward the pump and toward the nozzle, the nozzle pressure, the magnet valve stroke length, electrical supply phases to the electromagnet of the control valve, and the course of the nozzle needle stroke length when a control part of a control valve functioning as a throttle element is used.

### DESCRIPTION OF THE PREFERRED EMBODIMENTS

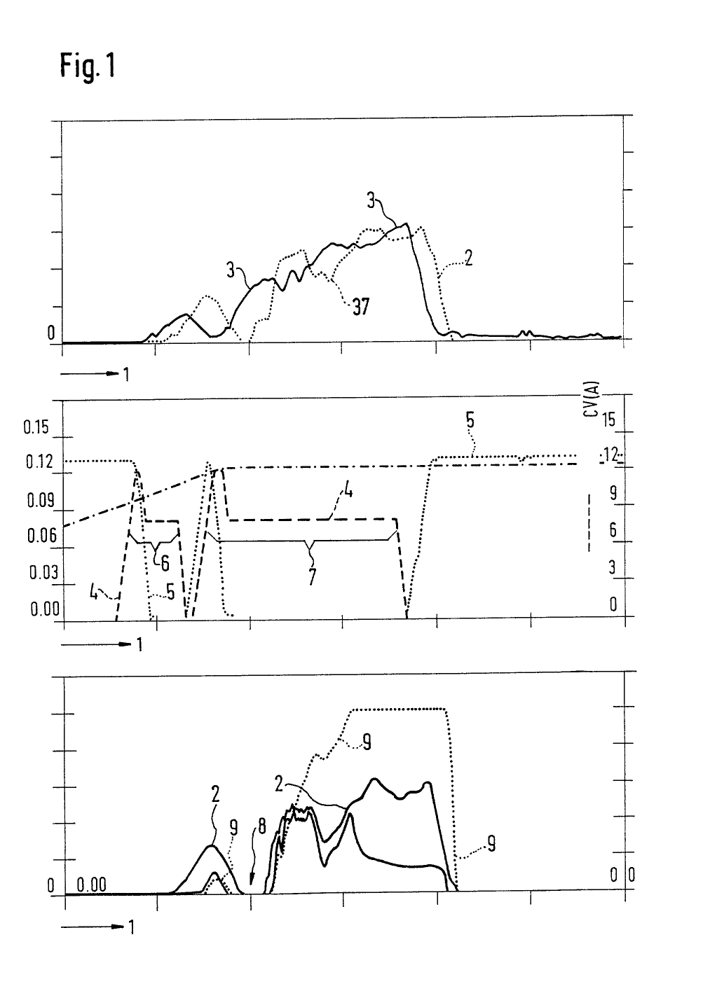

In FIG. 1, the courses of the nozzle pressure, magnet valve stroke length, electrical supply phases to the electromagnet that actuates the control valve, and the course of the nozzle needle stroke length can be seen, in each case plotted over the camshaft angle. The upper graph in FIG. 1 shows the pressure in the line 2 toward the nozzle and in the line 37 toward the pump, both plotted over the camshaft angle course 1. The pressure buildup on the nozzle side follows the course of the pressure buildup on the pump side, with a delay dictated by the high-pressure line 14. A first submaximum in the line 2 toward the nozzle ensues after the preinjection, while a nozzle high pressure extending over a longer period of time occurs in the region of the main injection phase 7 as shown by the middle graph.

In the middle graph of FIG. 1, for the system without a throttle valve, both the resultant magnet valve stroke length, represented by reference numeral 5, and the course 4 of electrical supply to an electromagnet that actuates a control valve are shown, both plotted over the camshaft angle course 1. During the preinjection phase 6, the magnet is supplied with current for a first period of time, resulting in a closure of the magnet valve. Once the preinjection has occurred, the magnet valve opens, and then by another supply of current to the actuator magnet, it closes again in accordance with the course of the electric supply 4 during the main injection phase 7. Once the main injection 7 has taken place, the electromagnet that actuates the control valve is again currentless, so that the control valve moves back into its open position in accordance with the further course of the magnet valve stroke length 5. In this range of the magnet valve stroke length 5, the control valve is for the most part in a stationary, steady state, as can be seen from the course of the magnet valve stroke length 5.

The courses of the nozzle needle stroke length 9 and the resultant nozzle pressure 2 are shown in the lower graph of FIG. 1.

To achieve smaller preinjection quantities, the injector is equipped with nozzle needle damping hardware. If the “boot injection” function is also provided for the injection system, then it can be expected that depending on the intensity of damping, the nozzle needle will remain in an intermediate position for the boot injection.

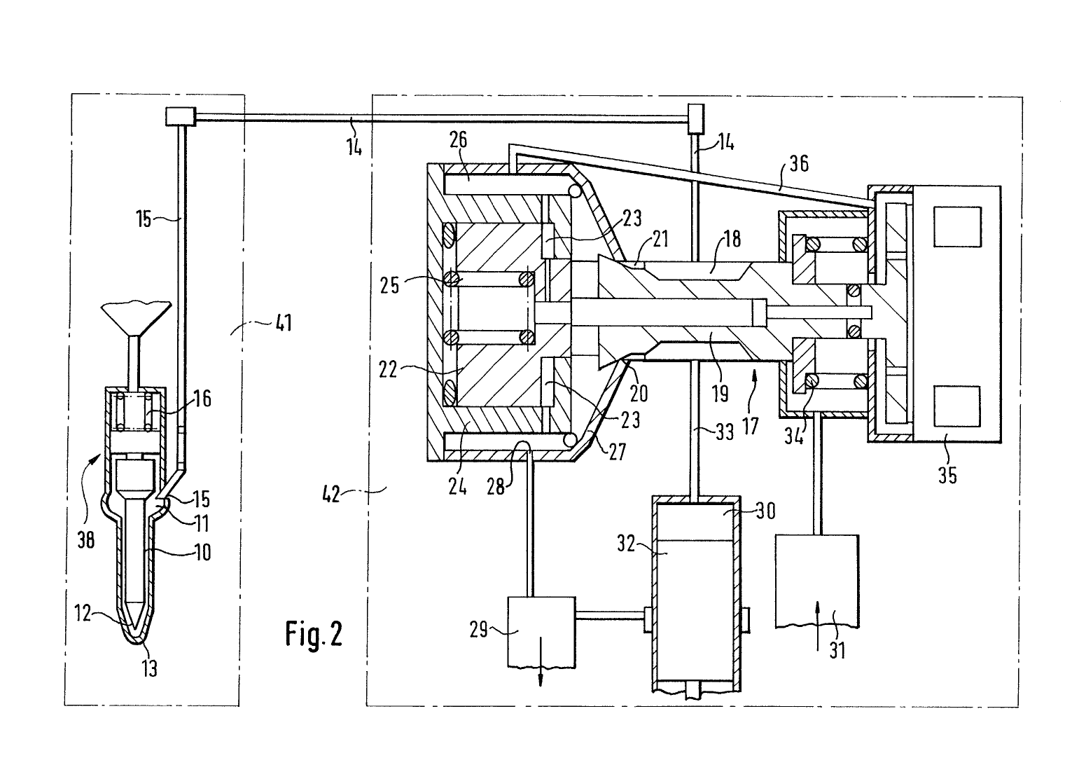

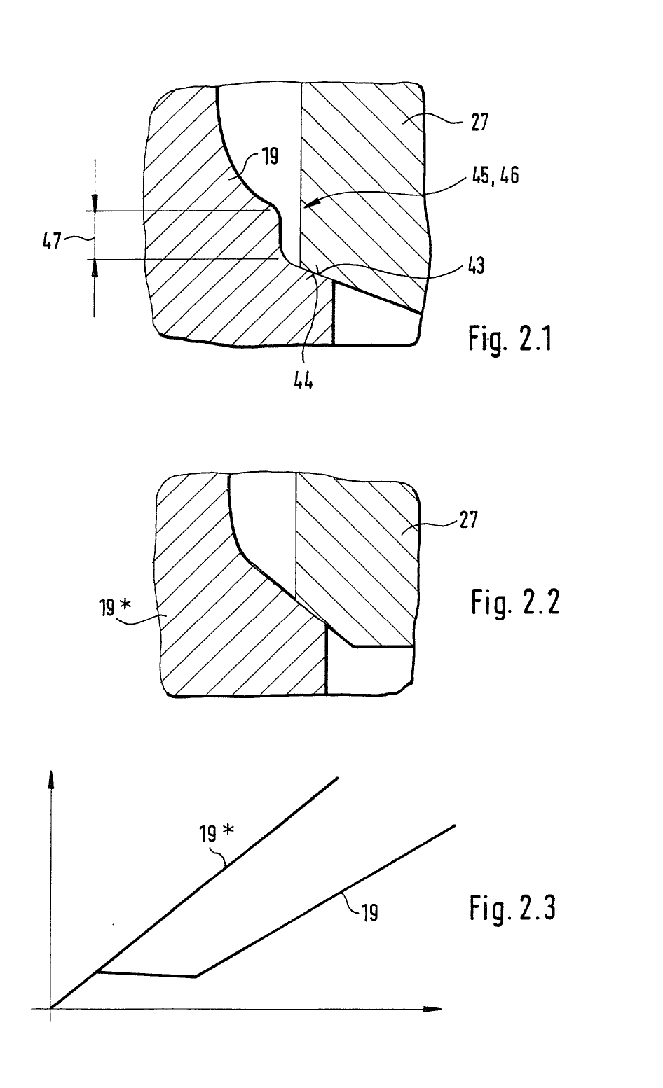

From this graph it can be seen that once the preinjection has taken place, a sharp drop 8 in the pressure occurs because part of the line system 14 has run empty; in the extreme case, this pressure even has a zero crossover, which is equivalent to the occurrence of negative pressure. Thus the line system known from the prior art entails the risk of cavitation, which on the one hand upon another pressure buildup, because of the collapse of the developing vapor bubbles, creates a severe, sudden stress on the material, and on the other can lead to a delay in the pressure buildup in the line system 14 (see FIG. 2). As a result, the injection sequences between the preinjection phase 6 and the main injection phase 7 are predetermined directly in their chronological sequence in accordance with the middle graph of FIG. 1. The zero crossover of the pressure in the nozzle chamber represented by the curve course 2 is adjoined by the main injection phase, which is characterized by a sharp increase in the nozzle pressure in the nozzle chamber. During the main injection phase 7, the travel distance of the nozzle from its seat attains a maximum, so that fuel quantity, metered in accordance with the instant of injection and duration of injection, can be injected into the combustion chamber of an internal combustion engine. The onset of the main injection is characterized by a pronounced pressure fluctuation in the nozzle chamber (FIG. 1, bottom graph).

In FIG. 2, components of a fuel injection system are shown, with a pump unit and an electromagnetically actuated control valve, as well as parts of the injection nozzle.

From the view in FIG. 2, it can be seen that the injector of the fuel injection system includes a nozzle needle 10, which is surrounded in a middle portion by a nozzle chamber 11. The injector bore 15 discharges into the nozzle chamber 11 and communicates in turn with the valve chamber 18 via the high-pressure line 14. In the lower region of the nozzle needle, a nozzle seat is provided, which once a certain pressure in the injection nozzle is reached causes an opening of the nozzle needle 10, so that a fuel injection into the combustion chamber of an engine can take place, in the form of a developing injection cone 13.

A compression spring element 16 with needle stroke damping 38 in hardware form is provided on the upper part of the nozzle needle 10, and with it the nozzle needle 10 can be prestressed in the nozzle needle housing.

The control valve 17 is seated in a valve chamber 18, provided in the pump housing 27, from which chamber the high-pressure line 14 branches off to the nozzle chamber 11 of the injection nozzle 10 and which communicates on the other side, via an inlet 33, with the pump chamber 30, 32 of the fuel supply system. The control part 19 is penetrated in the axial direction by a through bore and on its circumference, in the region of the low-pressure side end of the control part 19, it has a throttle element 21, as well as a conically extending control face 20. The conically extending control face 20 rests on a face, acting as a control edge, of the valve housing 27, which face is adjoined by a hollow chamber 26 inside the valve housing 27 in the low-pressure side. From the hollow chamber 26, which adjoins the throttling region 20, 21 of the control part 19 of the control valve 17, a return line 29, which can discharge into the fuel tank, branches off via a branch 28.

A short circuit to the pump chamber 30, 32 is provided at the return line 29, in order to reduce the leakage into the lubricant oil.

A valve stop 24 is received inside the hollow chamber 26 in the pump housing 27 of the control valve 17; that is, a passive piston 22 for the injection course shaping is received, which in turn is acted upon by the compression spring element 25. Between the valve stop 24 and the passive piston 22, a hollow chamber 23 is formed, which also communicates with the hollow chamber 26 inside the pump housing 27 on the low-pressure side by way of a relief bore in the stop 24. A bore 36 for fuel filling also branches off from the hollow chamber 26 and leads to the electromagnet-side end of the control valve 17. On the electromagnet-side end of the control valve 17, the electromagnet 35 that actuates the control valve 17, that is, the control part 19, is provided, and there again a compression spring 34 is received, which acts upon the control part 19 of the control valve 17.

The inlet line of a fuel inlet 31 discharges into the chamber, surrounding the compression spring element 34, of the control valve 17.

The throttle element, embodied in the form of a cross-sectional widening of the control part 19, can also be embodied, in a kinematic reversal, as a protrusion in the pump housing 27. The throttling action of the low-pressure side end of the control part 19 ensues because as a result of the control face 20 contacting the housing edge 27 of the pump housing, a throttled exiting of the fuel, at high pressure, present on the high-pressure side through high-pressure lines 14 and the valve chamber 18, into the hollow chamber 26 is assured. This prevents the high-pressure lines 14 to the nozzle chamber 11 from running empty, and also prevents the valve chamber 18 in the control valve 17 from running empty, so that cavitation cannot occur, nor can an excessive delay upon a resubjection of the valve chamber 18 or the high-pressure lines 14 to fuel at high pressure lead to delays in the injection sequence. The fuel entering the hollow chamber 26 of the pump housing 27 as a result of the throttling action is capable of flowing out both to the magnet valve-side end of the control valve 17 via the overflow conduit 36 and into the return line to the fuel tank 29 via the branch 28 in the hollow chamber 26.

The illustration in FIG. 2.1 provides an enlarged view of the throttling stages with adjacent control faces that close the outflow side.

FIG. 2.1 shows the valve seat 44 of the control part 19 in the built-in state in the housing. In the state shown, the valve 17 is closed. If the valve 17 is now opened, then because of the throttling edge 47 in comparison to a control part 19* without a throttling edge, a throttling occurs, with the course shown in FIG. 2.3. A control part 19* without a throttling edge can be seen in FIG. 2.2, and the course of the throttling is plotted in FIG. 2.3.

For the throttling, various possible embodiments exist as alternatives to those shown in FIG. 2.1. For example, the housing edge can be embodied as a throttle element. At the same time, by suitable design of valves and housing, throttle elements can be integrated in cascade form or in multiple stages.

Because of the throttling stages 45, 46 embodied on the control part 19, upon opening of the control part 19 in the axial direction a throttling action ensues, which limits the outflowing volumetric flow rate, so that the pressure prevailing in the supply line to the injection nozzle needle does not drop suddenly but instead drops only gradually. As a result, the remaining pressure level in the supply line to the injection nozzle, which protrudes into the combustion chamber of an internal combustion engine, can be maintained until such time as a preinjection phase is followed by a main injection phase. Since the pressure level in the supply line to the injection nozzle is still high enough, the main injection phase can follow the preinjection phase immediately. The sequence of preinjection phase and main injection phase can thus be achieved within a substantially shorter period of time. Since the pressure in the inlet bore to the injection nozzle does not drop to zero, no cavitation can be expected, so that the material stress in the region of the inlet bore embodied in the valve body can be limited.

In addition to the throttling action in the outflow-side control edge region 43, 44 between the valve chamber 18 and the pump housing 24 illustrated in conjunction with FIG. 2.1, a control of the outflow volume into the low-pressure side of the control valve 17 can also be achieved by a limitation of the axial stroke of the control valve 17. The limitation of the axial stroke is effected by means of a suitable positioning of a stop face on valve stop 24, so that by the contact of an end face with the stop face and the resultant or elicited size of the annular outflow gap, a controlled pressure drop in the inlet bore to the injection nozzle can be achieved; the outflow rate of the fuel, which is at high pressure, can be selected such that positive pressures always prevail in the inlet bore.

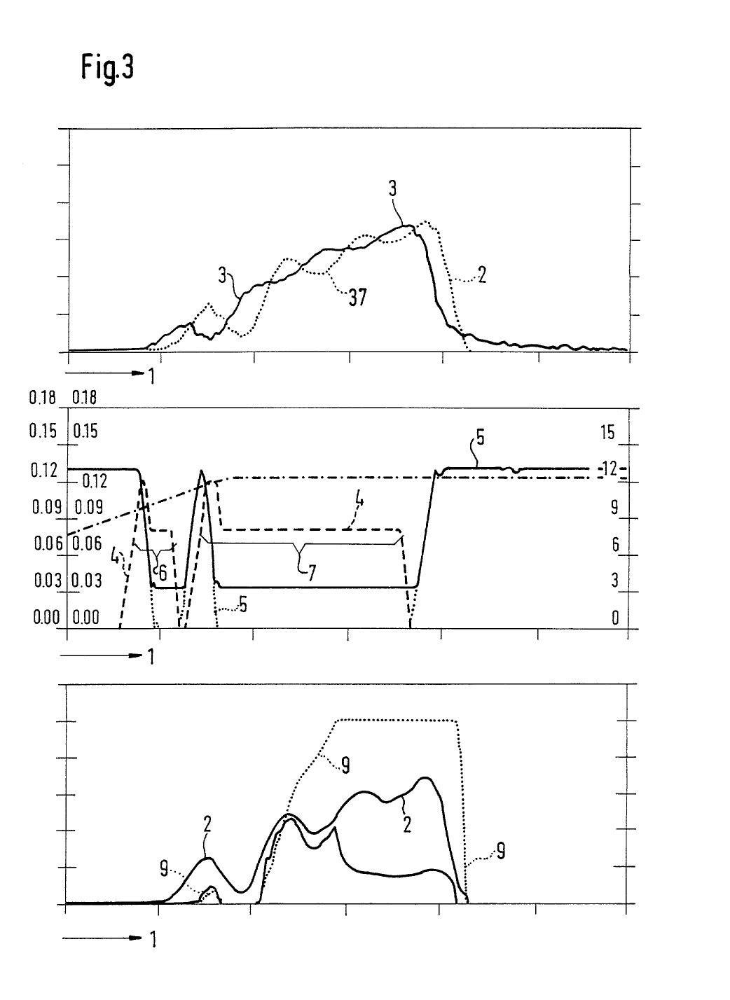

FIG. 3 shows the courses of the nozzle pressure, the magnet valve stroke length, the electrical supply phases of the electromagnet of the control valve, and the course of the nozzle needle stroke length when a control part 19 of a control valve 17 functioning as a throttle element is used.

The courses of the parameters of the control valve 17 are all plotted over the course of the camshaft angle 1. From the top graph, analogous to the top graph of FIG. 1, the pressure course in the line on the nozzle side 2 and pump side 3 can be seen, in each case plotted over the camshaft angle 1. In the middle graph in FIG. 3, the electrical supply phases of the electromagnet 35 of the control valve 17 are shown, during both the preinjection phase 6 and the main injection phase 7. The electrical supply phases of the electromagnet 35 result in the magnet valve stroke length course 5 indicated by the graph in FIG. 3, from which it can be seen that during both the main injection phase and the preinjection phase 6, the control part 19 of the control valve 17 moves into its closed position before it returns, once the main injection has ended, to its open position. From the bottom graph in FIG. 3, the resultant nozzle needle travel 9 is seen plotted over the camshaft angle 1, as well as the resultant nozzle pressure course 2 in the nozzle chamber 11 of the nozzle needle 10. In comparison with the bottom graph of FIG. 1, it can be seen that once the preinjection phase 6 has been completed, the pressure in the fuel injection system, and in particular in the high-pressure line 14 and the valve chamber 18 of the control valve 17, remains in a range of positive pressures and does not, as in the view of FIG. 1, execute a zero crossover 8. As a result of the residual pressure prevailing in the high-pressure line 14, a substantially faster succession of preinjection 6 and main injection 7 can be attained, since there is no need to fear cavitation in the lead line system and an attendant stress on material, nor is there a delayed pressure buildup in the line system 14. Since a zero crossover for the nozzle pressure course 2 in the nozzle chamber 11 which surrounds the nozzle needle 10 can be avoided, a substantially faster pressure buildup in the line system to the nozzle needle 10 can be attained during the main injection phase 7. During the main injection phase 7, the nozzle pressure course assumes an essentially trapezoidal shape, on which a slight pressure pulsation is superimposed in the bottom graph of FIG. 3.

The foregoing relates to preferred exemplary embodiments of the invention, it being understood that other variants and embodiments thereof are possible within the spirit and scope of the invention, the latter being defined by the appended claims.

We claim:

1. In an apparatus for controlling the injection sequences in fuel injection systems, including an injection nozzle (10) that can be acted upon via a control valve (17), which in turn can be acted upon by fuel via a pump chamber (30, 32), and the control valve (17) is actuatable by means of an electromagnet (35) which varies the control valve stroke length (2) and opens and closes the high-pressure line/bore (14, 18) in a nozzle chamber (11), the improvement wherein the control part (19) of the control valve (17) functions as a throttle element (21) in a low-pressure side hollow chamber (26).

2. The apparatus according to claim 1, further comprising a piston that shapes the injection course is disposed inside the low-pressure side hollow chamber (26).

3. The apparatus according to claim 1, wherein said low-pressure side hollow chamber (26) comprising an edge in the pump housing (27) which acts as a control edge for the control part (19, 19*) acting as a throttle element (21).

4. The apparatus according to claim 1, wherein the throttling action of the control part (19, 19*) and the control edge of the pump housing (27) is reinforced by the resultant spring force of force storing spring means (25, 34).

5. The apparatus according to claim 1, wherein the throttle cross section at the control part (19, 19*) of the control valve (17) is designed such that the high-pressure line system (14, 18) to the nozzle needle (10) is protected against running empty.

6. The apparatus according to claim 1, wherein the nozzle pressure course (2) between the preinjection phase (6) and the main injection phase (7) is always in the range of positive pressures.

7. The apparatus according to claim 1, wherein the throttle element (21) is embodied on the wall of the pump housing (27) of the control valve (17).

8. The apparatus according to claim 1, wherein a fuel return (28, 29) branches off from the hollow chamber (26) at the pump housing (27).

9. The apparatus according to claim 1, wherein by means of the control part (19, 19*) of the control valve (17), both a preinjection phase and a shaping of the injection course can be achieved.

10. The apparatus according to claim 1, wherein single- or multi-stage throttle elements (45, 46) are embodied on the outlet side in the region of control edges (43, 44) of the pump housing (27) and the control part (19, 19*).
